(19) United States
(12) Patent Application Publication
(10) Pub. No.: US 2025/0249673 A1
(43) Pub. Date: Aug. 7, 2025

(54) METHOD FOR MANUFACTURING TOUCH FILM AND TOUCH PAD

(71) Applicant: ASUSTEK COMPUTER INC., TAIPEI (TW)

(72) Inventor: Sheng-Yu TSAI, TAIPEI (TW)

(21) Appl. No.: 18/946,367

(22) Filed: Nov. 13, 2024

(30) Foreign Application Priority Data
Feb. 6, 2024 (CN) 202410167790.6

(51) Int. Cl. B32B 37/00; B32B 7/06; B32B 17/10; B32B 37/20; B32B 38/18; G06F 3/041

(52) U.S. Cl. CPC B32B 37/025; B32B 7/06; B32B 17/10; B32B 37/0053; B32B 37/203; B32B 38/18; G06F 3/041; B32B 2307/402; B32B 2457/208; G06F 2203/04103

(57) ABSTRACT

A method for manufacturing a touch film is provided, applicable to a glass thermal transfer device including a conveying apparatus, an unwinding apparatus, and a thermal transfer roller set. The method includes arranging a plurality of glass substrates in a preset gap on the conveying apparatus; arranging a transfer film on the unwinding apparatus, where the transfer film includes a substrate film, a release layer, a color layer, and a surface layer; sequentially conveying the glass substrates to a thermal transfer position by using the conveying apparatus; and continuously guiding the transfer film to the thermal transfer position by using the thermal transfer roller set and pressing the transfer film onto the glass substrate, to cause the surface layer and the color layer to be transferred to the glass substrates in a segmented manner according to a position of the preset gap, to form a plurality of touch films.

### CROSS-REFERENCE TO RELATED APPLICATION

This application claims the priority benefit of Chinese Application Serial No. 202410167790.6, filed on Feb. 6, 2024. The entirety of the above-mentioned patent application is hereby incorporated by reference herein and made a part of the specification.

### BACKGROUND OF THE INVENTION

### Field of the Invention

The disclosure relates to a touch technology, and in particular, to a method for manufacturing a touch film and a touch pad with the touch film.

### Description of the Related Art

With development of science and technology, a touch pad has been widely used in an electronic apparatus as an operation interface of a user. In addition, the user has increasingly higher requirements for appearance and a touch feel of the touch pad.

Glass is a material adapted to manufacture a surface film layer of the touch pad. However, a glass surface is too smooth and is not conducive for the user to perform operation. To resolve this problem, in a conventional practice, roughening needs to be performed on the glass surface in an etching manner. In addition, to impart color or another optical property to a glass touch film, a plurality of processes such as front and back printing and coating often needs to be performed, easily resulting in a low process yield.

### BRIEF SUMMARY OF THE INVENTION

The disclosure provides a method for manufacturing a touch film, applicable to a glass thermal transfer device. The glass thermal transfer device includes a conveying apparatus, an unwinding apparatus, and a thermal transfer roller set, the conveying apparatus includes a thermal transfer position, the unwinding apparatus is adapted to arrange a transfer film, and the thermal transfer roller set is arranged at the thermal transfer position. The method for manufacturing a touch film includes: arranging a plurality of glass substrates in a preset gap on the conveying apparatus; arranging the transfer film on the unwinding apparatus, where the transfer film includes a substrate film, a release layer, a color layer, and a surface layer, and the release layer, the surface layer, and the color layer are sequentially formed on the substrate film from bottom to top; sequentially conveying the glass substrates to the thermal transfer position by using the conveying apparatus; and continuously guiding the transfer film to the thermal transfer position and pressing the transfer film onto the glass substrate by using the thermal transfer roller set, to cause the surface layer and the color layer to be transferred to the glass substrates in a segmented manner according to a position of the preset gap, to form a plurality of touch films.

The disclosure further provides a touch pad. The touch pad includes a carrier, a circuit board, and a touch film formed by using the method for manufacturing a touch film. The circuit board is arranged on the carrier. The touch film is laminated on the circuit board.

According to the method for manufacturing a touch film in the disclosure, a glass thermal transfer device is used, to transfer a surface layer and a color layer on a transfer film to a glass substrate. In this way, the surface layer is manufactured based on a required surface roughness, and the color layer is formed by using ink and color that need to be coated. Then, the surface layer and the color layer are transferred to a surface of the glass substrate by using a thermal transfer roller set. Compared with a conventional method for treating a surface of a touch film of a glass substrate, in the disclosure, cumbersome processes are integrated into a simple thermal transfer step, so that heavy work is easy to perform, and a yield is increased, thereby reducing loss of the glass substrate.

### BRIEF DESCRIPTION OF THE DRAWINGS

FIG. 1 is a flowchart of a method for manufacturing a touch film according to an embodiment of the disclosure;

FIG. 2 is a schematic diagram of a glass thermal transfer device to which the method for manufacturing a touch film in FIG. 1 is applicable;

FIG. 3 is a schematic diagram of a transfer film used in the method for manufacturing a touch film in FIG. 1;

FIG. 4 is a schematic diagram of a transfer film according to another embodiment of the disclosure;

FIG. 5 is a schematic top view of the transfer film in FIG. 3; and

FIG. 6 and FIG. 7 show a manufacturing procedure of a touch pad according to an embodiment of the disclosure.

### DETAILED DESCRIPTION OF THE EMBODIMENTS

Specific embodiments of the disclosure are described in detail below with reference to schematic diagrams. Advantages and features of the disclosure are clearer from the following descriptions and the claims. It is to be noted that, the drawings are drawn by using an extremely simplified form and imprecise proportion, which are only used for conveniently and clearly assisting in explaining the objective of the embodiments of the disclosure.

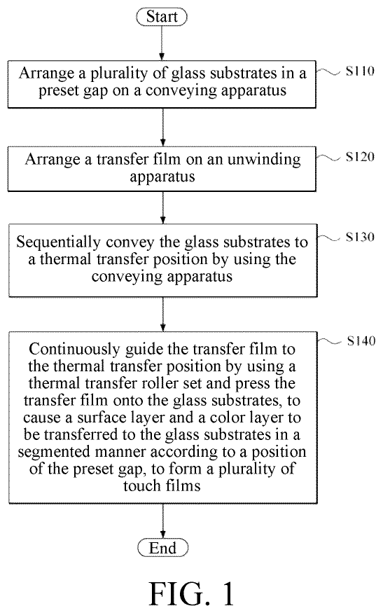

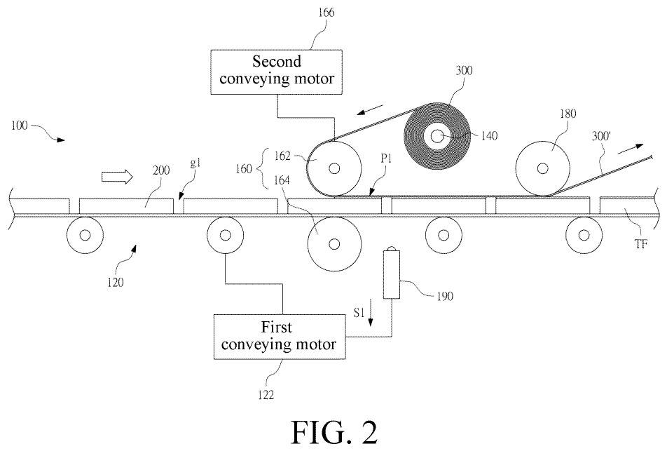

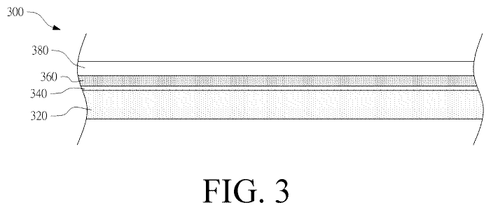

FIG. 1 is a flowchart of a method for manufacturing a touch film according to an embodiment of the disclosure. FIG. 2 is a schematic diagram of a glass thermal transfer device to which the method for manufacturing a touch film in FIG. 1 is applicable. FIG. 3 is a schematic diagram of a transfer film used in the method for manufacturing a touch film in FIG. 1.

The method for manufacturing a touch film in this embodiment is applicable to a glass thermal transfer device 100 shown in FIG. 2. The glass thermal transfer device 100 includes a conveying apparatus 120, an unwinding apparatus 140, and a thermal transfer roller set 160.

The conveying apparatus 120 is adapted to place a glass substrate 200, and adapted to convey the glass substrate 200 to a thermal transfer position P1. In an embodiment, the conveying apparatus 120 is a conveying belt, and the conveying apparatus 120 includes a first conveying motor 122. The first conveying motor 122 controls a conveying speed of the conveying apparatus 120.

The unwinding apparatus 140 is adapted to arrange a transfer film 300. The transfer film 300 is placed on the unwinding apparatus 140 in a roll form. The thermal transfer roller set 160 is arranged at the thermal transfer position P1, to guide the transfer film 300 and transfer a film layer on the transfer film 300 to the glass substrate 200 through combined action of heat and pressure, to change a surface property of the glass substrate 200 to form the touch film. Details of the transfer film 300 are described in more detail in the following paragraphs.

In an embodiment, the thermal transfer roller set 160 includes an upper roller 162 and a lower roller 164 respectively arranged on an upper side and a lower side of the conveying apparatus 120. The upper roller 162 of the thermal transfer roller set 160 directly comes into contact with the transfer film 300. The upper roller 162 heats the transfer film 300 and presses the transfer film 300 onto the glass substrate 200, and drives the transfer film 300 to continue moving forward. The lower roller 164 is arranged below the glass substrate 200, to heat the glass substrate 200. In an embodiment, the thermal transfer roller set 160 alternatively includes only the upper roller 162. In addition, in an embodiment, the thermal transfer roller set 160 is connected to a second conveying motor 166. The second conveying motor 166 controls a rotation speed of the upper roller 162, so that a conveying speed of the transfer film 300 is controlled.

Further, in an embodiment, to make movement of the transfer film 300 smoother, the glass thermal transfer device 100 further includes a winding apparatus 180 arranged downstream of the thermal transfer position P1, to collect a transfer film 300′ (mainly a substrate film on the transfer film 300′) completing a thermal transfer process.

Referring to FIG. 1 and FIG. 2, such a glass surface treatment method includes the following steps.

First, as described in step S110, a plurality of glass substrates 200 is arranged in a preset gap g1 on the conveying apparatus 120.

Subsequently, as described in step S120, the transfer film 300 is arranged on the unwinding apparatus 140.

Referring to FIG. 3, FIG. 3 is a schematic diagram of the transfer film 300 according to an embodiment of the disclosure. As shown in the figure, the transfer film 300 includes a substrate film 320, a release layer 340, a surface layer 360, and a color layer 380. The release layer 340, the surface layer 360, and the color layer 380 are sequentially formed on the substrate film 320 from bottom to top. When the transfer film 300 is wound into a roll, the color layer 380 faces outward. When the transfer film 300 is guided to the thermal transfer position P1, the transfer film 300 is turned upside down, and the color layer 380 of the transfer film 300 faces downward, in other words, is toward the glass substrate 200.

In an embodiment, the substrate film 320 is a PET film layer. The release layer 340 is made of a release agent, and is coated on the substrate film 320, to facilitate transfer of the surface layer 360 and the color layer 380 from the substrate film 320 to the glass substrate 200.

The surface layer 360 determines a touch feel of a surface of the touch film. In an embodiment, the surface layer 360 is a textured film, and a side of the surface layer 360 toward the release layer 340 has a rough surface. In other embodiments, the surface layer 360 is alternatively an anti-glare coating layer, an anti-fingerprint coating layer, or a high-hardness film layer. In addition, if the surface layer 360 is the textured film or a high-hardness film layer with a protective effect, an anti-glare coating layer is additionally formed between the surface layer 360 and the color layer 380, to provide an anti-glare effect.

The color layer 380 determines color presented by the touch film as a whole. The color layer 380 is not limited to presenting a single color, and alternatively presents a color change. Further, in an embodiment, the color layer 380 alternatively presents a pattern or a text by using ink or pigment. In terms of a manufacturing method, the color layer 380 is formed on the surface layer 360 in a printing manner.

Next, as described in step S130, the glass substrates 200 are sequentially conveyed to the thermal transfer position P1 by using the conveying apparatus 120.

Then, as described in step S140, the transfer film 300 is continuously guided to the thermal transfer position P1 by using the thermal transfer roller set 160 and pressed onto the glass substrate 200, to cause the surface layer 360 and the color layer 380 to be transferred to the glass substrates 200 in a segmented manner according to a position of the preset gap g1, to form a plurality of touch films LF.

In a process in which the thermal transfer roller set 160 transfers the surface layer 360 and the color layer 380 to the glass substrate 200, the thermal transfer roller set 160 (in particular, the upper roller 162) abuts against the preset gap g1 between the glass substrates 200, to perform segmentation on the surface layer 360 and the color layer 380 of the transfer film 300. In this way, the thermal transfer roller set 160 automatically transfers the surface layer 360 and the color layer 380 to the glass substrates 200 in the segmented manner according to the position of the preset gap g1 between the plurality of glass substrates 200, to form the plurality of touch films TF.

In an embodiment, a width of the preset gap g1 is set to be approximately equal to a thickness of the glass substrate 200, to avoid ensuring that the surface layer 360 and the color layer 380 of the transfer film 300 are automatically transferred to each of the glass substrates 200 in the segmented manner, and avoid that the thermal transfer roller set 160 transfers the surface layer 360 and the color layer 380 of the transfer film 300 to the conveying belt.

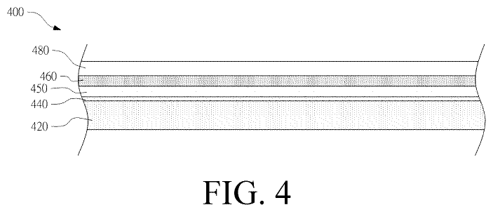

Referring to FIG. 4, in the embodiment of FIG. 3, the transfer film 300 includes the substrate film 320, the release layer 340, the surface layer 360, and the color layer 380. The color layer 380 is an uppermost layer of the transfer film 300.

FIG. 4 is a schematic diagram of a transfer film 400 according to another embodiment of the disclosure. In an embodiment, the transfer film 400 includes a substrate film 420, a release layer 440, an anti-fingerprint coating layer 450, a surface layer 460, and a color layer 480. Compared with the embodiment of FIG. 3, in this embodiment, the anti-fingerprint coating layer 450 is formed on a side of the surface layer 460 toward the release layer 440, in other words, between the surface layer 460 and the release layer 440. After being transferred to the glass substrate 200, the anti-fingerprint coating layer 450 is located on an outermost layer of a surface of the glass substrate 200.

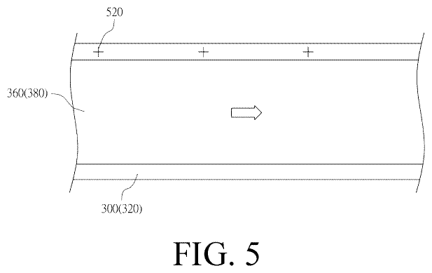

Referring to FIG. 5, FIG. 5 is a schematic top view of the transfer film 300 in FIG. 3. As shown in the figure, an edge of the transfer film 300 has a plurality of positioning marks 520. The positioning mark 520 is a circle, a square, or a mark of another geometric shape. In an embodiment, the positioning marks 520 are arranged at the edge of the transfer film 300 at a fixed interval, to facilitate confirmation of a relative position between the transfer film 300 and the glass substrate 200. In addition, a movement distance of the transfer film 300 is determined by using the positioning mark.

Referring to FIG. 2, in an embodiment, an optical detection apparatus 190, namely, a camera, is arranged on the glass thermal transfer device 100.

The optical detection apparatus 190 is arranged downstream of the thermal transfer position P1, to detect the positioning mark 520 to generate a detection signal S1. At least one of the first conveying motor 122 and the second conveying motor 166 performs operation according to the detection signal S1. In other words, the conveying speed of the conveying apparatus 120 or the conveying speed of the transfer film 300 is adjusted according to the detection signal S1, to ensure that the surface layer 360 and the color layer 380 on the transfer film 300 are completely transferred to the glass substrate 200.

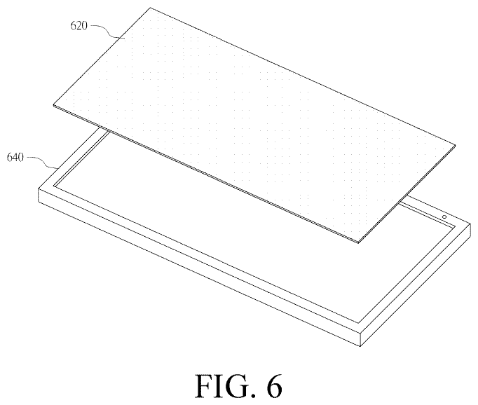

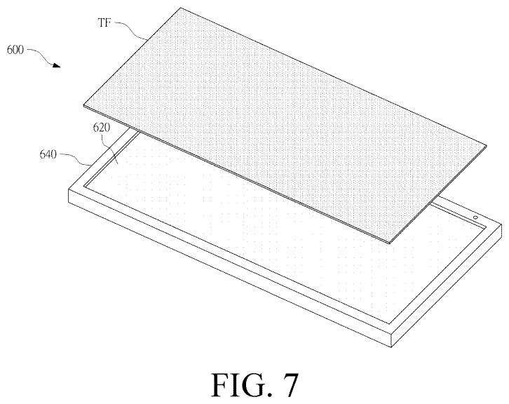

FIG. 6 and FIG. 7 show a manufacturing procedure of a manufacturing method for a touch pad 600 according to an embodiment of the disclosure.

First, as shown in FIG. 5, a circuit board 620 is arranged on a carrier 640. Subsequently, as shown in FIG. 6, a touch film TF formed by using the method for manufacturing a touch film shown in FIG. 1 is laminated on the circuit board 620, to form the touch pad 600 of the disclosure.

According to a method for manufacturing a touch film of the disclosure, a surface layer 360 and a color layer 380 on a transfer film 300 are transferred to a glass substrate 200 by using a glass thermal transfer device 100. In this way, the surface layer 360 is manufactured based on a required surface roughness, and the color layer 380 is formed by using ink and color that need to be coated. Then, the surface layer 360 and the color layer 380 are transferred to a surface of the glass substrate 200 by using a thermal transfer roller set 160. Compared with a conventional method for treating a surface of a touch film of a glass substrate, in the disclosure, cumbersome processes are integrated into a simple thermal transfer step, so that heavy work is easy to perform, and a yield is increased, thereby reducing loss of the glass substrate.

Although the disclosure is described with reference to the foregoing embodiments, the embodiments are not intended to limit the disclosure. A person with ordinary knowledge in the art makes variations and improvements without departing from the spirit and scope of the disclosure. Therefore, the protection scope of the disclosure is defined by the claims.

What is claimed is:

1. A method for manufacturing a touch film, applicable to a glass thermal transfer device, wherein the glass thermal transfer device comprises a conveying apparatus, an unwinding apparatus, and a thermal transfer roller set, the conveying apparatus comprises a thermal transfer position, the unwinding apparatus is adapted to arrange a transfer film, and the thermal transfer roller set is arranged at the thermal transfer position, and the method comprising:
arranging a plurality of glass substrates in a preset gap on the conveying apparatus;
arranging the transfer film on the unwinding apparatus, wherein the transfer film comprises a substrate film, a release layer, a surface layer, and a color layer, and the release layer, the surface layer, and the color layer are sequentially formed on the substrate film from bottom to top;
sequentially conveying the plurality of glass substrates to the thermal transfer position by using the conveying apparatus; and
continuously guiding the transfer film to the thermal transfer position and pressing the transfer film onto the glass substrate by using the thermal transfer roller set, to cause the surface layer and the color layer to be transferred to the plurality of glass substrates in a segmented manner according to a position of the preset gap, to form a plurality of touch films.

2. The method according to claim 1, wherein the thermal transfer roller set comprises an upper roller and a lower roller respectively arranged on an upper side and a lower side of the conveying apparatus.

3. The method according to claim 1, wherein the surface layer is an anti-glare coating layer, an anti-fingerprint coating layer, or a high-hardness film layer.

4. The method according to claim 1, wherein the transfer film further comprises an anti-glare coating layer formed between the surface layer and the color layer.

5. The method according to claim 1, wherein the transfer film further comprises an anti-fingerprint coating layer formed between the surface layer and the release layer.

6. The method according to claim 1, wherein the glass thermal transfer device further comprises a winding apparatus arranged downstream of the thermal transfer position, to collect the transfer film completing a thermal transfer process.

7. The method according to claim 1, wherein the conveying apparatus is a conveying belt.

8. The method according to claim 1, wherein an edge of the transfer film has a plurality of positioning marks, the glass thermal transfer device further comprises an optical detection apparatus, and the optical detection apparatus is arranged downstream of the thermal transfer position, to detect the positioning mark to generate a detection signal.

9. The method according to claim 8, wherein the conveying apparatus comprises a first conveying motor, the thermal transfer roller set is connected to a second conveying motor, and at least one of the first conveying motor and the second conveying motor performs operation according to the detection signal.

10. The method according to claim 1, wherein the touch film is applicable to a touch pad.

11. A touch pad, comprising:
a carrier;
a circuit board, arranged on the carrier; and
a touch film formed by using the method according to claim 1, laminated on the circuit board.
